(19) United States
(12) Patent Application Publication
(10) Pub. No.: US 2026/0099546 A1
(43) Pub. Date: Apr. 9, 2026

(54) EXTENSIBLE RESEARCH AND DISCOVERY TOOL

(71) Applicant: Kevin ROARK, Brooklyn, NY (US)

(72) Inventor: Kevin ROARK, Brooklyn, NY (US)

(21) Appl. No.: 19/350,279

(22) Filed: Oct. 6, 2025

Related U.S. Application Data
(60) Provisional application No. 63/703,411, filed on Oct. 4, 2024.

(51) Int. Cl. G06F 16/901; G06F 16/26

(52) U.S. Cl. CPC G06F 16/9024; G06F 16/26

(57) ABSTRACT

A software toolkit for research and discovery is disclosed. The software toolkit includes a data model defining entity objects and document objects, a configuration system for describing object data structures, a rendering engine for generating user interface components based on the configuration system, a linking system for connecting entity objects and document objects, and a search and exploration interface for accessing and analyzing linked objects. The configuration system may further include a declarative language for defining object attributes and relationships.

### CROSS-REFERENCE TO RELATED APPLICATIONS

This application claims the benefit of priority to U.S. Provisional Application No. 63/703,411, entitled “EXTENSIBLE RESEARCH AND DISCOVERY TOOL” and filed Oct. 4, 2024. The entire contents of which are incorporated herein by reference in their entirety.

### TECHNICAL FIELD

The present disclosure relates generally to software for research and data organization. More particularly, the present disclosure relates to extensible systems for defining, linking, and exploring structured data objects. The disclosed techniques may be applied to, for example, sports analytics, business intelligence, academic research, and other fields requiring flexible data management and analysis.

### BACKGROUND

Research and data organization are critical components across various fields, including sports analytics, business intelligence, and academic research. As the volume and complexity of available data continues to grow, there is an increasing need for flexible and powerful tools to manage, analyze, and derive insights from diverse information sources.

Traditional data management systems often struggle to handle the dynamic nature of modern research environments. These systems typically rely on rigid database structures and predefined relationships between data elements, limiting their ability to adapt to evolving research needs. Furthermore, many existing solutions lack intuitive interfaces for non-technical users, creating barriers to effective data exploration and analysis.

The process of linking and exploring related pieces of information across different data types and sources is a common challenge in research and discovery. Researchers and analysts frequently need to connect disparate data points, such as documents, entities, and events, to uncover meaningful patterns and insights. However, existing tools often fall short in providing seamless ways to establish and navigate these connections.

Search and exploration capabilities are essential for deriving value from large datasets. While many systems offer basic search functionality, they may lack advanced filtering, sorting, and visualization options that enable users to efficiently process and understand complex information landscapes. Additionally, the ability to customize and save specific views or dashboards is often limited, hindering users'ability to tailor the system to their specific research workflows.

As research teams become more diverse and collaborative, there is a growing need for systems that can accommodate varying levels of technical expertise. Many current solutions require significant programming knowledge to configure and extend functionality, limiting their accessibility to a broader user base. This can create bottlenecks in research processes and hinder the adoption of potentially valuable tools.

The rapid pace of technological advancement, particularly in areas such as artificial intelligence and machine learning, presents both opportunities and challenges for research and discovery systems. Integrating these new technologies into existing workflows while maintaining system flexibility and user-friendliness is an ongoing challenge in the field.

Given these considerations, there is a clear need for more adaptable, user-friendly, and powerful tools to support modern research and discovery processes across various domains. Such tools should ideally combine flexible data modeling, intuitive user interfaces, advanced search and exploration capabilities, and the ability to evolve alongside changing research requirements and technological advancements.

### BRIEF DESCRIPTION OF DRAWINGS

The accompanying drawings, which are incorporated in and form a part of the specification, illustrate the embodiments of the invention and together with the written description serve to explain the principles, characteristics, and features of the invention. Various aspects of at least one example are discussed below with reference to the accompanying drawings, which are not intended to be drawn to scale. In the drawings:

FIG. 1 depicts a flowchart of a method for organizing and exploring research data in accordance with an embodiment.

FIG. 2 depicts an illustrative intel search user interface for a research and discovery system in accordance with an embodiment.

FIG. 3 depicts another illustrative intel search user interface for a research and discovery system in accordance with an embodiment.

FIG. 4 depicts an illustrative intel editor interface in accordance with an embodiment.

FIG. 5 depicts an illustrative administrative user interface of a research and discovery system in accordance with an embodiment.

FIG. 6 depicts a block diagram of a data processing system for activity monitoring and recap generation in accordance with an embodiment.

FIG. 7 depicts a system architecture diagram showing the relationship between configuration, entity, association, and document layers in accordance with an embodiment.

FIG. 8 depicts a block diagram of a system architecture including configuration, processing, access control, and output modules in accordance with an embodiment.

FIG. 9 illustrates a block diagram of a data processing system in which embodiments are implemented.

### DETAILED DESCRIPTION

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Those having skill in the art can also translate from the plural form to the singular as is appropriate to the context and/or application. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to. ”

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices also can “consist essentially of” or “consist of” the various components and steps, and such terminology should be interpreted as defining essentially closed-member groups.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B. ”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art.

The present disclosure provides a software toolkit designed for research and discovery across various domains. The toolkit may include a data model that defines entity objects and document objects, providing a flexible structure for organizing and managing diverse types of data. The toolkit may also include a configuration system that describes object data structures, enabling users to customize the data model to suit their specific research needs.

The data model may be implemented using object-relational mapping (ORM) frameworks such as Hibernate, Django ORM, or SQLAlchemy, providing abstraction layers between application code and database systems. The data model may support schema-on-read approaches with compatibility for JSON, XML, and binary data formats, enabling flexible data ingestion from various sources. The toolkit may also include a configuration system that describes object data structures, enabling users to customize the data model to suit their specific research needs. The configuration system may utilize declarative schema definition languages such as JSON Schema, Apache Avro, or Protocol Buffers for structured data definition. The system may support schema evolution, versioning, and backward compatibility through migration frameworks and schema registries such as Confluent Schema Registry or Apache Pulsar Schema Registry. These technical implementations provide benefits including database independence, flexible data modeling, automated schema management, and seamless system evolution.

In some embodiments, the toolkit may include a rendering engine that generates user interface components based on the configuration system. This engine may allow for the dynamic creation of various interface elements, such as tables, cards, filters, and forms, enhancing the user's ability to interact with and analyze the data.

The toolkit may further include a linking system that allows for forming connections between entity objects and document objects. In some embodiments, portions of these connections may be arbitrary. The system may facilitate the establishment of complex relationships between different data elements, thereby enabling more comprehensive and insightful data exploration. The linking system may be implemented through a graph database. The system may utilize graph algorithms including shortest path algorithms (Dijkstra, A*), centrality measures (PageRank, betweenness centrality), and community detection algorithms (Louvain, Label Propagation) for relationship analysis. The linking system may employ graph query languages such as Cypher, Gremlin, or SPARQL for complex relationship traversals and pattern matching. Relationship storage may utilize adjacency lists, adjacency matrices, or specialized graph storage formats optimized for traversal performance. The system may implement graph indexing strategies including vertex-centric indices, edge indices, and composite indices for efficient query processing. These technical implementations provide benefits including efficient relationship traversal, complex pattern matching capabilities, scalable graph operations, and intuitive relationship modeling.

Additionally, the toolkit may provide a search and exploration interface for accessing and analyzing the linked objects. This interface may offer advanced search capabilities, customizable filters, and sorting options, that allow users to efficiently navigate the data landscape and derive meaningful insights. The search and exploration interface may be implemented through enterprise search platforms such as Elasticsearch, Apache Solr, or Amazon CloudSearch for comprehensive data indexing and retrieval. The search system may employ inverted indexing, term frequency-inverse document frequency (TF-IDF) scoring, and BM25 ranking algorithms for relevance scoring. Advanced search capabilities may include fuzzy search using edit distance algorithms, phonetic search through Soundex or Metaphone algorithms, and semantic search using dense vector representations generated by transformer models. The interface may offer customizable filters implemented through faceted search architectures, range queries, geo-spatial filtering using R-tree or Quadtree indexing, and temporal filtering with specialized time-series indexing. Query processing may employ query optimization techniques including query rewriting, predicate pushdown, and parallel execution. These technical implementations provide benefits including fast full-text search, scalable indexing, flexible query capabilities, and comprehensive data discovery.

In various embodiments, the toolkit may be designed to be extensible and adaptable, capable of serving a wide range of research and discovery applications across different fields. This flexibility may make the toolkit a powerful tool for sports analytics, business intelligence, academic research, and other areas requiring sophisticated data management and analysis capabilities.

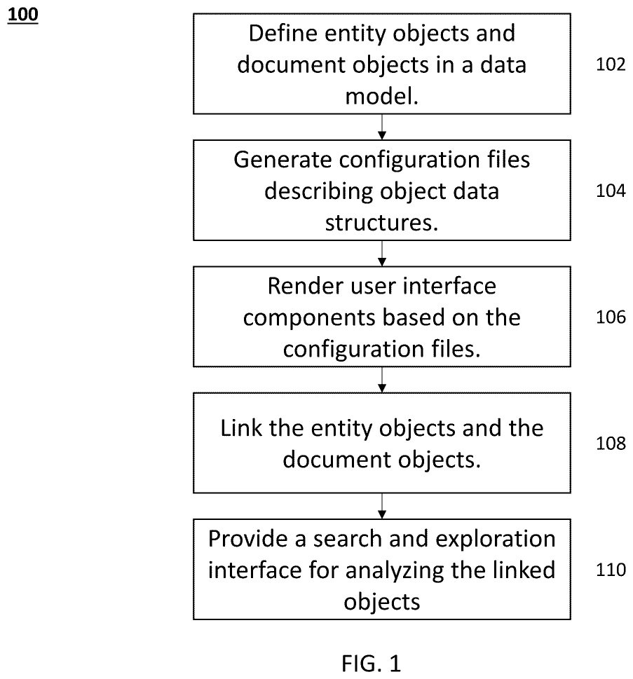

Referring to FIG. 1, a flowchart for a method 100 for organizing and exploring research data is depicted. The method 100 may include defining 102 entity objects and document objects in a data model. In some aspects, the entity objects may represent various types of entities relevant to the research domain. For example, in sports analytics entities may include, but are not limited to, users, teams, players, leagues, and coaches. The document objects may represent different types of documents or data records, such as intel, scouting reports, contracts, season stats, and the like. The data model may provide a flexible and extensible structure for organizing and managing diverse types of data, thereby facilitating efficient data exploration and analysis.

In some aspects, the method 100 includes generating 104 configuration files that describe the object data structures. In some cases, these configuration files may be written in a declarative language, which allows for the definition of object attributes and relationships in a straightforward and intuitive manner. The configuration files may describe the structure, properties, and relationships of the entity objects and document objects, thereby providing a blueprint for the organization of the research data.

In some embodiments, the configuration files may be generated by a configuration system included in the software toolkit. The configuration system may provide a user-friendly interface for defining object data structures, thereby enabling users to customize the data model to suit their specific research needs. The configuration system may also support the use of templates or predefined object structures, which can simplify and expedite the process of data model configuration.

In some aspects, the generation of configuration files may be automated through machine learning techniques. Machine learning algorithms may analyze existing data structures, user interactions, and research patterns to suggest optimal configurations for entity objects and document objects. These algorithms may identify common attributes, relationships, and usage patterns across different research domains, and use this information to generate configuration files that are tailored to specific research needs. The machine learning system may employ various types of neural networks including deep neural networks such as transformer-based models (e.g., BERT, GPT variants) for natural language processing of configuration requirements, convolutional neural networks (CNNs) for pattern recognition in data structures, and recurrent neural networks (RNNs) or Long Short-Term Memory (LSTM) networks for sequential data analysis. Clustering algorithms such as k-means, hierarchical clustering, or DBSCAN may be employed to identify patterns across different research domains. Reinforcement learning models may optimize configuration suggestions based on user feedback and system performance metrics. The system may also utilize ensemble methods combining multiple machine learning approaches, such as random forests or gradient boosting machines, to improve prediction accuracy. These AI models provide benefits including automated pattern recognition, adaptive learning from user behavior, reduced manual configuration effort, and discovery of non-obvious data relationships Automated configurations may be provided to a user for confirmation. The machine learning system may continuously learn and improve its suggestions based on user feedback and system performance metrics. As a result, the system may streamline the configuration process, reduce manual effort, and potentially uncover valuable data structures that human users might overlook. Additionally, the machine learning system may adapt to evolving research requirements over time, automatically proposing updates to the configuration files as new data patterns emerge.

In some embodiments, the method 100 includes rendering 106 user interface components based on the configuration files. A rendering engine may interpret the configuration files and generate corresponding user interface components. These components may include, but are not limited to, tables, cards, filters, and forms. Each of these components may serve a specific function in the user interface, facilitating the interaction between the user and the research data.

For instance, tables may be used to display data in a structured and organized manner, allowing users to easily compare and analyze different data elements. Cards may provide a more visual and interactive way of presenting data, enabling users to quickly grasp key information in a concise format. Filters may allow users to refine their data view based on specific criteria, thereby enhancing the efficiency and effectiveness of data exploration. Forms may facilitate data input and modification, enabling users to easily add, edit, or delete data elements.

In some cases, the rendering engine may generate user interface components dynamically based on the current state of the data model and the user's interaction with the system. This dynamic rendering capability may allow the user interface to adapt to changes in the research data and user preferences, thereby providing a more responsive and personalized user experience.

The method 100 may include linking 108 entity objects and document objects. This step may involve establishing arbitrary connections or relationships between different data elements, thereby enabling the creation of a complex and interconnected data landscape. The linking system may allow for the linking of any combination of entity and document objects, thereby providing a high degree of flexibility in the organization and exploration of the research data.

In some cases, the linking of entity objects and document objects may be based on various criteria or rules, such as common attributes, shared relationships, or user-defined associations. The linking system may also support the creation of multi-level or hierarchical links, thereby enabling the representation of complex relationships or dependencies between different data elements. The linking system may further provide mechanisms for managing and updating the links, thereby ensuring the consistency and integrity of the research data.

In some aspects, machine learning algorithms may be employed to automatically link or provide recommendations for links between entity objects and document objects. These algorithms may analyze patterns in existing links, content similarity, metadata, and user behavior to suggest potential connections. The system may utilize techniques such as natural language processing, clustering, and collaborative filtering to identify relationships between objects that may not be immediately apparent to human users. The machine learning models may include graph neural networks (GNNs) such as Graph Convolutional Networks (GCNs), GraphSAGE, or Graph Attention Networks (GATs) for analyzing complex relationships between entities. Natural language processing models such as transformer-based architectures (BERT, RoBERTa, or domain-specific variants) may analyze textual content for semantic similarity. Word embedding models like Word2Vec, GloVe, or FastText may be used for feature extraction, while sentence embedding models such as Sentence-BERT or Universal Sentence Encoder may capture document-level semantics. Collaborative filtering techniques such as matrix factorization, non-negative matrix factorization (NMF), or deep collaborative filtering models may identify patterns based on user behavior. These AI models provide benefits including automated relationship discovery, improved data connectivity, reduced manual linking effort, enhanced research insights through hidden pattern detection, and scalable processing of large datasets. As users interact with the system, the machine learning models may continuously refine their recommendations, adapting to evolving research needs and data patterns. This automated linking capability may enhance the efficiency of data organization, uncover hidden insights, and facilitate more comprehensive exploration of the research landscape.

In some embodiments, the method 100 includes providing 110 a search and exploration interface for accessing and analyzing the linked objects. The interface may offer advanced search capabilities, customizable filters, and sorting options, allowing users to efficiently navigate the data landscape and derive meaningful insights. The search and exploration interface may be designed to be intuitive and user-friendly, catering to users with varying levels of technical proficiency.

In some aspects, the user interface may present objects based on their links to other objects, offering a more dynamic and interconnected approach to data organization compared to traditional filing systems. This presentation method may allow users to navigate through related information seamlessly, regardless of where the data is stored or how it is categorized. By leveraging the linking system, the interface may display objects in context with their connections, potentially revealing insights that might be obscured in a hierarchical file structure (e.g., a traditional folder-based system). This approach may enable more intuitive and flexible data exploration because users can traverse the information landscape based on the inherent connections between objects rather than predetermined categories or file paths.

In some embodiments, the software toolkit may be implemented as a non-transitory computer-readable medium storing instructions that, when executed by a processor, cause the processor to perform operations for a research and discovery system. These operations may include maintaining a database of entity objects and document objects, processing configuration files that describe object data structures, generating user interface components based on the processed configuration files, managing links between entity objects and document objects, and facilitating search and exploration of the linked objects through a user interface. This implementation may enable the software toolkit to be deployed on various computing platforms and devices, thereby enhancing its accessibility and usability.

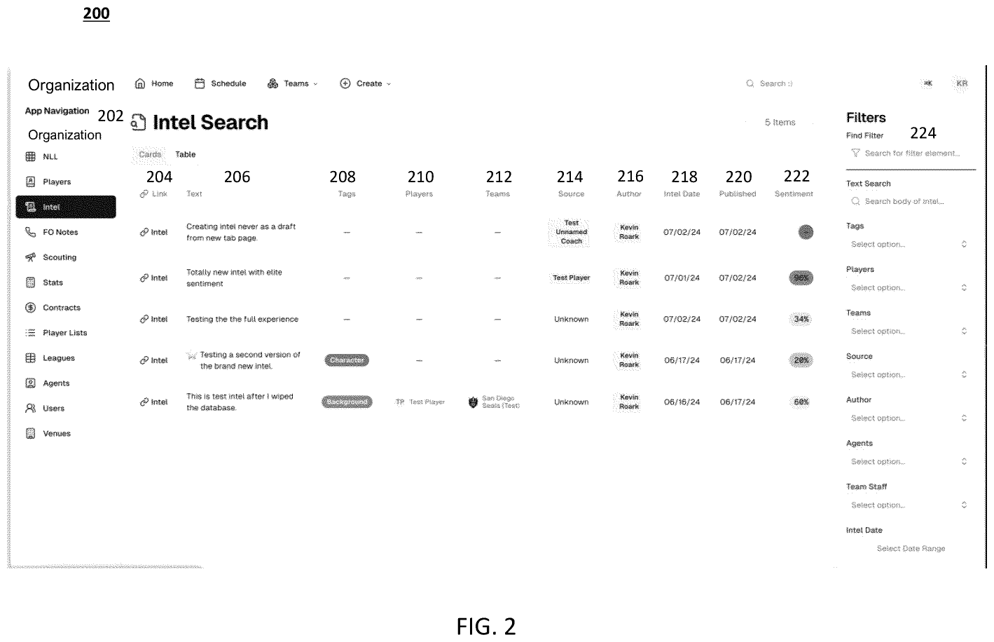

Referring to FIG. 2, an illustrative intel search user interface 200 is depicted. The intel search user interface 200 may be generated by the rendering engine based on the configuration files. The interface 200 includes a navigation panel 202 and a filter panel 224, both of which are designed to facilitate the exploration and analysis of linked objects within the research and discovery system.

As illustrated in FIG. 2, the user interface 200 may display search results in a tabular format with several columns providing various details about each intel item. Example details may include a link 204 to the subject intel or underlying document, relevant text 206, tags 208, players 210, teams 212, source 214, author 216, an intel date 218, a publication date 220, and sentiment 222. The link 204 may provide direct access to individual intel items, while the text 206 may offer a brief description or excerpt of the intel. The tags 208 may categorize the intel based on relevant keywords or themes. The players 210 and teams 212 columns may indicate the specific individuals or groups related to the intel. The source 214 and author 216 columns may provide information about the origin and creator of the intel, respectively. The intel date 218 and publication date 220 may provide temporal context for the intel, and the sentiment 222 may offer a quick visual indicator of the intel's tone or implications.

Although the example includes references to sports analytics. A person of ordinary skill in the art will understand that the user interface 200 may be adapted to other uses. For example, teams may be replaced by a company in a business intelligence application.

The filter panel 224 may allow users to refine their search results based on various criteria. The filter panel 224 may include options for text search, tags, players, teams, source, author, agents, team staff, intel date range, or any other structured data type. This customizable filtering capability may enhance the efficiency and effectiveness of data exploration, thereby enabling users to focus on intel items that are most relevant to their research needs.

In some cases, the intel search user interface 200 may include a navigation menu 202, that provides access to various sections of the system such as schedule, teams, and player lists. At the top of the interface, there may be options for accessing or creating new intel. The navigation menu may facilitate easy navigation within the system, to enhance the user experience.

In some embodiments, the intel search user interface 200 may be configured to be intuitive and user-friendly. As such, the user interface 200 may cater to users with varying levels of technical proficiency. The interface 200 may also be dynamic, so that it may adapt to changes in the research data and user preferences. This dynamic nature of the interface 200 may provide a more responsive and personalized user experience.

In certain embodiments, the intel search user interface 200 may be configured to support various data visualization formats, such as card view, calendar view, scatter plots, timelines, and others. These different visualization formats may provide users with diverse perspectives on the research data, thereby facilitating more comprehensive and insightful data analysis.

In some embodiments, the filter panel 224 may be designed to support advanced filtering capabilities, such as multi-criteria filtering, range filtering, and fuzzy matching. Multi-criteria filtering may allow users to apply multiple filter options simultaneously, enabling more precise refinement of the search results. Range filtering may allow users to specify a range of values for a certain data attribute, such as intel date, thereby to enable temporal exploration of the intel items. Fuzzy matching may allow users to search for intel items based on approximate or partial matches of the search text, thereby enhancing the flexibility of the text search. The advanced filtering system may be implemented through sophisticated data processing architectures including multi-dimensional indexing structures such as R-trees, KD-trees, or LSH (Locality-Sensitive Hashing) for efficient spatial and temporal filtering. Faceted search functionality may be implemented using inverted indices, bitmap indices, or columnar storage formats like Apache Parquet for rapid query processing. Fuzzy matching capabilities may be powered by edit distance algorithms (Levenshtein, Jaro-Winkler), phonetic matching algorithms (Soundex, Metaphone), or neural fuzzy matching models using character-level or subword embeddings. The system may implement approximate string matching through n-gram indexing, suffix arrays, or BK-trees for efficient similarity search. These technical implementations provide benefits including faster query response times, scalable filtering across large datasets, flexible search capabilities, and improved user experience through responsive interfaces.

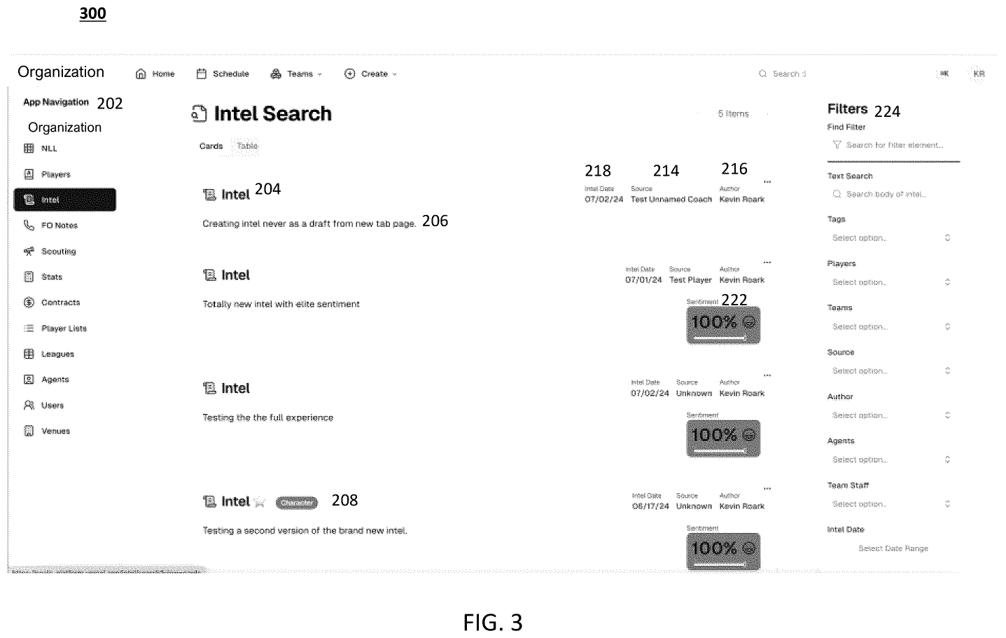

FIG. 3 illustrates an alternative card view of an example intel search user interface 300. The user interface 300 may provide similar information as referenced in regard to FIG. 2 in a more detailed view on an object-by-object basis.

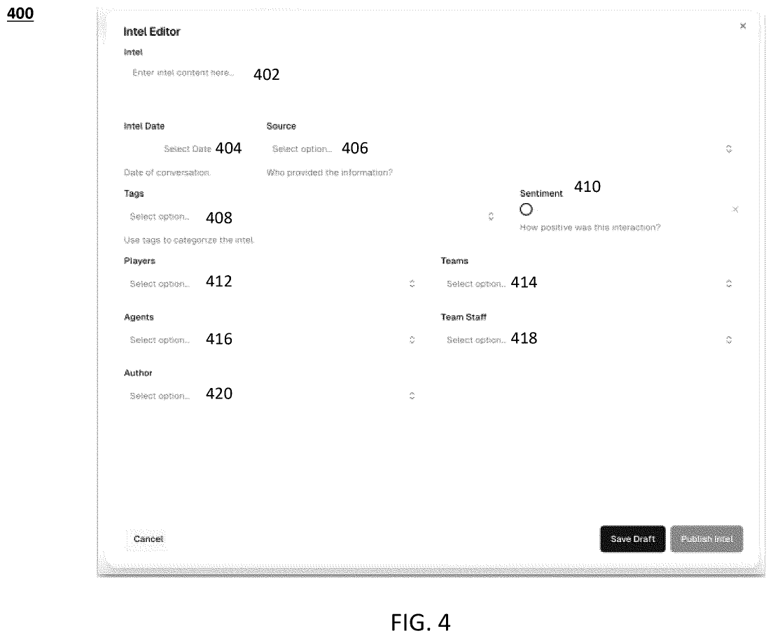

Referring to FIG. 4, an intel editor interface 400 is depicted. The intel editor interface 400 may be configured to facilitate the input and categorization of information within the research and discovery system. In some aspects, the intel editor interface 400 may include several components for inputting and categorizing information, which may enhance the user's ability to interact with and manage the research data.

The interface 400 may include a content input field 402 for entering intel content. The field 402 may allow users to input text (structured or unstructured), images, videos, links, or other types of content, providing a flexible and versatile platform for data input. In some cases, the content input field 402 may support various text formatting options, such as bold, italic, underline, and bullet points, thereby enabling users to create rich and informative intel content. In some embodiments, the system may be configured to extract information from the input. Extraction may include processing the input to recognize text (i.e., optical character recognition) and/or recognizing potential data fields in unstructured information.

The interface 400 may include a date selector 404 and/or a source selector 406. The date selector 404 may allow users to specify the intel date, to provide temporal context for the intel. The source selector 406 may allow users to identify the origin of the information, thereby enhancing the traceability and credibility of the intel.

The intel editor interface 400 may also include a sentiment indicator 410. The sentiment indicator 410 may allow users to rate the positivity of the interaction, to provide a quick visual indicator of the intel's tone or implications. In some aspects, the sentiment indicator 410 may be represented by a sliding bar, a percentage, and/or an emoji. The sentiment indicator 410 may offer an intuitive and user-friendly way of expressing sentiment.

In some aspects, the system may determine sentiment by analyzing the input through various natural language or image processing techniques. The system may employ machine learning algorithms trained on large datasets of text, imagery, or video to identify and classify emotional tone, opinion, and attitude expressed in the intel content. These algorithms may consider factors such as word choice, sentence structure, context, the presence of specific keywords or phrases, facial expressions, or other body language associated with positive, negative, or neutral sentiments. The system may utilize transformer-based language models such as BERT, RoBERTa, DistilBERT, or domain-specific variants fine-tuned on sentiment analysis datasets. Convolutional neural networks (CNNs) may be used for text classification, while recurrent neural networks including LSTM and GRU architectures may capture sequential dependencies in text. For multimodal sentiment analysis, the system may integrate computer vision models such as ResNet, VGG, or EfficientNet for facial expression recognition, combined with pose estimation models like OpenPose or MediaPipe for body language analysis. These AI models provide benefits including automated sentiment detection, consistent emotional analysis across large datasets, real-time processing capabilities, multimodal analysis combining text and visual cues, and reduced subjective bias in sentiment assessment.

In some cases, the system may also take into account more subtle linguistic cues, such as sarcasm or irony, to provide a more nuanced sentiment analysis. The sentiment analysis results may be represented as a numerical score or percentage, which can then be translated into a visual indicator such as an emoji for quick and intuitive understanding by users.

The interface 400 may contain multiple selector fields. These may include a players selector 412 and a teams selector 414 for associating the intel with specific players and teams. Additionally, selectors for agents 416 and team staff 418 may allow for further categorization of the intel. These selectors 412, 414, 416, and 418 may allow users to link the intel to various entities in the data model, thereby enhancing the interconnectedness and explorability of the research data.

The interface 400 may include an author selector 420, which can be used to attribute the intel to a specific author. This selector 420 may allow users to acknowledge the creator of the intel, thereby promoting accountability and transparency in the research process.

In some embodiments, the system may automatically weight values based on other values. For example, a given source or author may provide intel with a sentiment that differs substantially that of of other sources or authors. In certain embodiments, intel associated with the source or author may be automatically normalized to accommodate this difference.

In some embodiments, the intel editor interface 400 may be designed to be intuitive and user-friendly, catering to users with varying levels of technical proficiency. The interface 400 may include visual cues and interactive elements, such as dropdown menus, checkboxes, and sliders, to facilitate the selection of options and the input of information. The interface 400 may also provide feedback to the users, such as highlighting the selected options and updating the displayed intel items in real-time based on the inputted information.

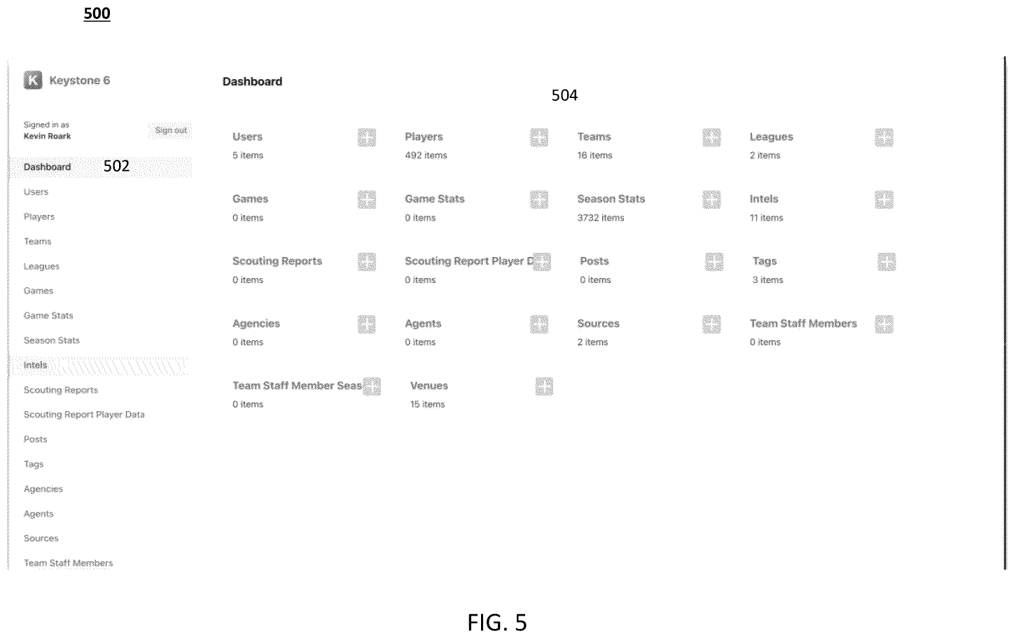

Referring to FIG. 5, an administrative user interface 500 of the research and discovery system is depicted. In some aspects, the user interface 500 may include dashboard content 504, which provides an overview of the research and discovery system's data categories. The dashboard content 504 may be displayed in a grid layout, showing multiple data categories and the number of items in each category. This grid layout may provide a visual summary of the research data, enabling users to quickly grasp the overall structure and distribution of the data.

In some cases, the dashboard content 504 may include an add button for creating new entries in each category. This add button may allow users to easily add new data elements to the system, thereby enhancing the flexibility and usability of the research and discovery system. The add button may be conveniently located within each data category, to provide a direct and intuitive way for users to contribute to the research data.

In some embodiments, the user interface 500 may also include a navigation menu 502, located on the left side of the interface. The navigation menu 502 may provide access to various sections of the system, such as Dashboard, Users, Players, Teams, Leagues, Games, Game Stats, Season Stats, Intels, Scouting Reports, and others. This navigation menu 502 may facilitate easy navigation within the system to enhance the user experience.

In some embodiments, the software toolkit may further comprise a permission-based data access system for controlling user access to objects. This system may allow administrators to assign different access rights to different users, thereby ensuring the security and privacy of the research data. For instance, a user may be granted read-only access to certain data categories, while another user may be granted full access to all data categories. This permission-based data access system may be integrated with the user interface 500. Administrators may manage user access rights directly from the interface using the permission-based access system.

In some cases, the software toolkit may encode filter values, sort keys, ids, and other parameters in a URL of the user interface 500. This feature may make every URL in the system savable and shareable, thereby enhancing the usability of the system. By encoding these parameters in the URL, the state of the user interface 500 may be preserved and restored. As a result, the system may be easier to use and more intuitive for the users.

In other embodiments, the software toolkit may allow for the creation of custom components for specific needs that do not fit into the system paradigm. In certain aspects, the custom components may be written by developers using React and TypeScript, and integrated into the system as needed. Other programming tools may also be used within the scope of this disclosure. This feature may provide a high degree of flexibility and extensibility. As such, the system may cater to a wide range of research and discovery applications.

In some aspects, the configuration files used in the software toolkit may be written in a declarative language for defining object attributes and relationships. This declarative language may allow users to specify what they want the system to do, rather than how to do it. This approach may simplify the process of defining object data structures, and make the system more accessible to non-technical users. The use of a declarative language may also enhance the maintainability and scalability of the system, as changes to the data model can be made by modifying the configuration files, rather than the underlying code.

In some embodiments, the software toolkit may utilize a data fetching architecture that leverages React Server Components. This architecture may allow for the fetching of type-safe data on the backend, which can be sorted and filtered on the server side. The fetched data may then be sent to the client as rendered react-data, rather than as JSON data. This approach may reduce the occurrence of errors in the translation of data from the backend to the frontend, as the API data structure can change without the client's knowledge, thereby preventing potential system breakdowns. The use of React Server Components in the data fetching architecture may also enhance the performance and efficiency of the system because it reduces the amount of data that needs to be sent to the client and the amount of client-side processing required.

The architecture may be further enhanced through implementation of microservices-based system design with event-driven communication using message queues such as Apache Kafka, RabbitMQ, or Amazon SQS for asynchronous processing. The backend may employ containerized microservices deployed using Docker and orchestrated with Kubernetes, enabling horizontal scaling and fault tolerance. Data fetching may utilize GraphQL APIs with query optimization, field-level caching, and batching mechanisms to minimize network overhead. The system may implement distributed caching layers using Redis, Memcached, or Apache Ignite for improved response times. Database sharding and replication strategies may be employed across multiple database systems including PostgreSQL for relational data, MongoDB for document storage, and Neo4j for graph relationships. These technical implementations provide benefits including improved scalability, reduced latency, enhanced fault tolerance, and optimized resource utilization.

In some cases, the software toolkit may implement a consistent visual language across the user interfaces. This visual language may be based on generic user interface components and tailwind theming and may provide a uniform and intuitive user experience. The use of generic user interface components may simplify the design and development process, as the same components may be reused across different parts of the interface. The tailwind theming may allow for the customization of the visual appearance of the interface, enabling the system to adapt to different branding and aesthetic preferences. The consistent visual language may also enhance the usability of the system, as users can easily recognize and understand the interface elements based on their consistent appearance and behavior.

The visual language implementation may be enhanced through a comprehensive design system architecture utilizing a component library built with modern web technologies including TypeScript, styled-components, or CSS-in-JS solutions such as Emotion or styled-jsx. The design system may utilize atomic design principles with a hierarchical component structure including atoms, molecules, organisms, templates, and pages. Tailwind CSS theming may be extended with custom design tokens managed through tools like Style Dictionary or Theo, enabling systematic color palettes, typography scales, spacing systems, and animation curves. The component library may implement accessibility standards (e.g., WCAG 2.1 AA) with Accessible Rich Internet Applications (ARIA) attributes, keyboard navigation support, and screen reader compatibility. These technical implementations provide benefits including improved development efficiency, consistent user experience, enhanced accessibility, a maintainable codebase, and scalable design systems.

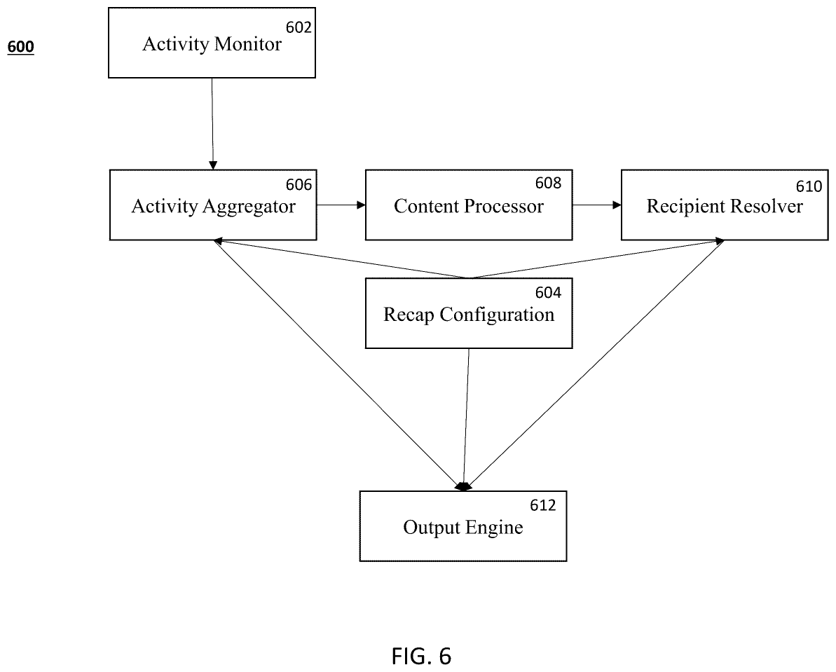

Referring to FIG. 6, a data processing system 600 for activity monitoring and recap generation is depicted. The data processing system 600 may include an activity monitor 602 that tracks user interactions, data modifications, and system events within the research and discovery platform. The activity monitor 602 may capture various types of activities including document creation, entity updates, search queries, and user collaboration events. In some aspects, the activity monitor 602 may employ event streaming architectures for real-time activity capture and processing.

The system 600 may include a recap configuration 604 that defines parameters for generating activity summaries and notifications. The recap configuration 604 may specify aggregation rules, recipient lists, content templates, and delivery schedules for different types of recap communications. In some embodiments, the recap configuration 604 may support customizable time windows, such as daily, weekly, or monthly recap periods, and may allow for different configuration profiles based on user roles or organizational hierarchies.

An activity aggregator 606 may process the captured activities from the activity monitor 602 according to the rules defined in the recap configuration 604. The activity aggregator 606 may group related activities, calculate summary statistics, and identify significant events or trends within the specified time periods.

The system 600 may include a content processor 608 that transforms the aggregated activity data into human-readable content for recap communications. The content processor 608 may generate textual summaries, create visualizations, and format the information according to predefined templates or user preferences. In some aspects, the content processor 608 may utilize natural language processing to create personalized and contextually relevant recap content.

A recipient resolver 610 may determine the appropriate recipients for each recap communication based on the recap configuration 604 and user access permissions. The recipient resolver 610 may consider factors such as user roles, data access rights, organizational structure, and individual notification preferences when identifying who should receive specific recap information. In some embodiments, the recipient resolver 610 may integrate with directory services or user management systems to maintain accurate recipient information.

The system 600 may include an output engine 612 that handles the final delivery of recap communications to the identified recipients. The output engine 612 may support multiple delivery channels including email, in-application notifications, mobile push notifications, or integration with external communication platforms. In some cases, the output engine 612 may implement delivery optimization features such as batching, rate limiting, and retry mechanisms to ensure reliable communication delivery.

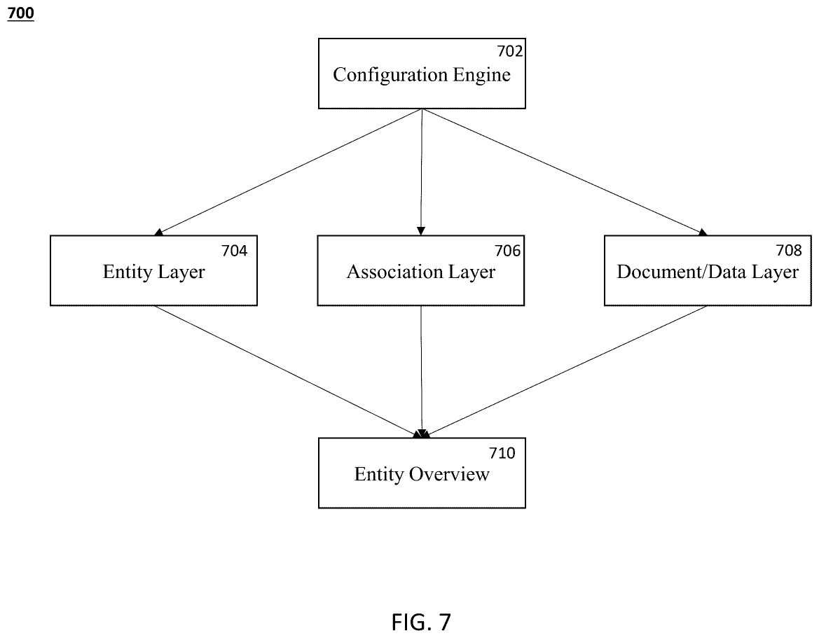

Referring to FIG. 7, a system architecture 700 illustrating the relationship between configuration, entity, association, and document layers is depicted. The system architecture 700 may include a configuration engine 702 that serves as the central orchestrator for defining and managing the data model structure. The configuration engine 702 may process declarative configuration files that specify entity schemas, document types, association rules, and user interface definitions. In some aspects, the configuration engine 702 may support schema validation, dependency resolution, and configuration versioning to ensure system consistency and reliability.

The architecture 700 may include an entity layer 704 that manages structured data objects representing people, places, organizations, and other domain-specific entities. The entity layer 704 may define entity schemas with attributes such as names, contact information, locations, and industry classifications. In some embodiments, the entity layer 704 may support hierarchical entity relationships, entity inheritance, and dynamic attribute extensions based on the configuration definitions.

An association layer 706 may manage the relationships and connections between entities and documents within the system. The association layer 706 may support many-to-many relationships, temporal metadata, and contextual attributes that describe the nature and significance of connections between different data objects. In some cases, the association layer 706 may implement graph-based storage and querying capabilities to efficiently navigate complex relationship networks.

The architecture 700 may include a document data layer 708 that handles various types of unstructured and semi-structured content including reports, analyses, notes, and multimedia files. The document data layer 708 may support content indexing, metadata extraction, and full-text search capabilities. In some aspects, the document data layer 708 may integrate with content management systems, file storage services, and document processing pipelines to handle diverse content types and formats.

An entity overview 710 may provide a unified view that integrates information from the entity layer 704, association layer 706, and document data layer 708. The entity overview 710 may present comprehensive profiles that include entity details, associated documents, recent activity timelines, and related data metrics. In some embodiments, the entity overview 710 may support customizable views, interactive visualizations, and drill-down capabilities to facilitate comprehensive data exploration and analysis.

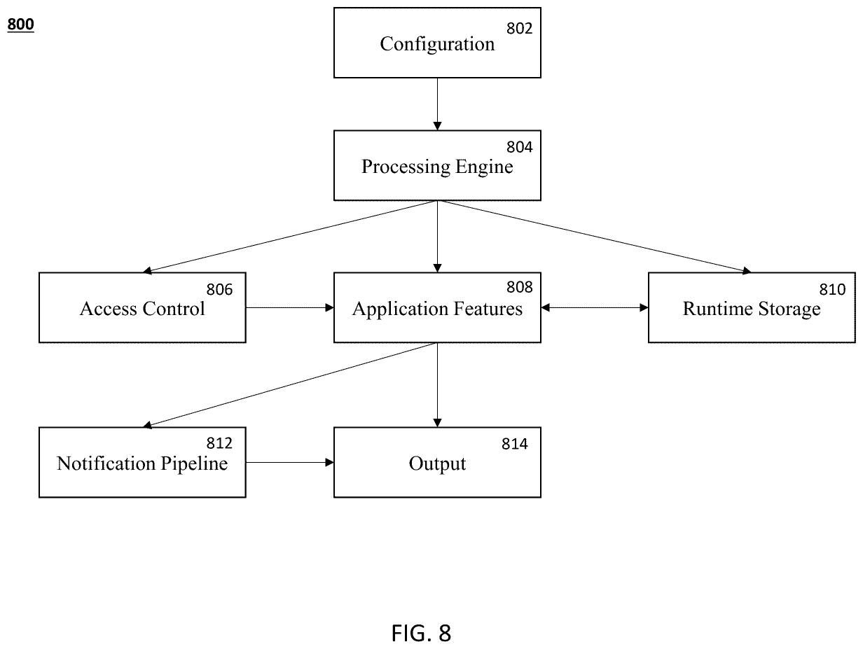

Referring to FIG. 8, a system architecture 800 showing the relationship between configuration, processing, access control, and output modules is depicted. The system architecture 800 may include a configuration module 802 that manages TypeScript configuration files defining entity schemas, document types, association rules, and user interface specifications. The configuration module 802 may support configuration parsing, validation, and transformation to generate the necessary system components and database schemas.

A processing engine 804 may serve as the central orchestrator that coordinates the compilation and generation of system components based on the configuration definitions. The processing engine 804 may handle schema validation, dependency resolution, code generation, and component instantiation. In some aspects, the processing engine 804 may implement a plugin architecture that allows for extensible processing capabilities and custom transformation logic.

The architecture 800 may include an access control module 806 that manages user authentication, authorization, and permission enforcement throughout the system. The access control module 806 may support role-based access control, attribute-based permissions, and fine-grained data access policies. In some embodiments, the access control module 806 may integrate with external identity providers, support single sign-on capabilities, and maintain audit trails for security compliance.

An application features module 808 may encompass the core functionality of the research and discovery system including document creation interfaces, entity management tools, search capabilities with filter engines, and view rendering components. The application features module 808 may generate user interfaces dynamically based on the configuration definitions and may support customizable workflows and user experience adaptations.

The architecture 800 may include a runtime storage module 810 that manages the persistent storage of entities, documents, associations, and system metadata. The runtime storage module 810 may support multiple database technologies, implement data partitioning strategies, and provide transaction management capabilities. In some cases, the runtime storage module 810 may employ polyglot persistence approaches using different storage systems optimized for specific data types and access patterns.

A notification pipeline 812 may handle activity tracking, data aggregation, content generation, and communication delivery for system notifications and recap communications. The notification pipeline 812 may support configurable notification rules, multiple delivery channels, and personalized content generation. In some aspects, the notification pipeline 812 may implement event-driven architectures with message queuing and asynchronous processing capabilities.

The architecture 800 may include an output module 814 that generates the final user interfaces and system outputs including staff work interfaces and decision maker dashboards. The output module 814 may support responsive design, customizable layouts, and interactive data visualizations. In some embodiments, the output module 814 may provide export capabilities, reporting functions, and integration APIs for external systems and third-party applications.

### Example Embodiments

In some embodiments, software toolkit for research and discovery includes a data model defining entity objects and document objects; a configuration system for describing object data structures; a rendering engine for generating user interface components based on the configuration system; a linking system for connecting entity objects and document objects; and a search and exploration interface for accessing and analyzing linked objects.

In some embodiments, the configuration system includes a declarative language for defining object attributes and relationships.

In some embodiments, the rendering engine generates at least one of: tables, cards, filters, and forms based on the configuration system.

In some embodiments, the software toolkit includes a permission-based data access system for controlling user access to objects.

In some embodiments, the search and exploration interface includes customizable filters and sorting options for analyzing linked objects.

In some embodiments, the search and exploration interface further includes a dashboard for displaying aggregated data from linked objects.

In some embodiments, the dashboard is configurable by non-technical users to create custom views of linked object data.

In some embodiments, a method for organizing and exploring research data, includes defining entity objects and document objects in a data model; generating configuration files describing object data structures; rendering user interface components based on the configuration files; linking entity objects and document objects arbitrarily; and providing a search and exploration interface for accessing and analyzing the linked objects.

In some embodiments, the configuration files are generated using a declarative language for defining object attributes and relationships.

In some embodiments, rendering user interface components includes generating at least one of: tables, cards, filters, and forms based on the configuration files.

In some embodiments, the method includes implementing a permission-based data access system for controlling user access to objects.

In some embodiments, the search and exploration interface includes customizable filters and sorting options for analyzing linked objects.

In some embodiments, the method includes generating a dashboard for displaying aggregated data from linked objects.

In some embodiments, the dashboard is configurable by non-technical users to create custom views of linked object data.

In some embodiments, a non-transitory computer-readable medium stores instructions that, when executed by a processor, cause the processor to perform operations for a research and discovery system, the operations including maintaining a database of entity objects and document objects; processing configuration files that describe object data structures; generating user interface components based on the processed configuration files; managing links between entity objects and document objects; and facilitating search and exploration of the linked objects through a user interface.

In some embodiments, the configuration files are written in a declarative language for defining object attributes and relationships.

In some embodiments, generating user interface components includes creating at least one of: tables, cards, filters, and forms based on the processed configuration files.

In some embodiments, the operations include implementing a permission-based data access system for controlling user access to objects.

In some embodiments, facilitating search and exploration includes providing customizable filters and sorting options for analyzing linked objects.

In some embodiments, the operations include generating a configurable dashboard for displaying aggregated data from linked objects, wherein the dashboard is customizable by non-technical users to create personalized views of linked object data.

### Example Computing System

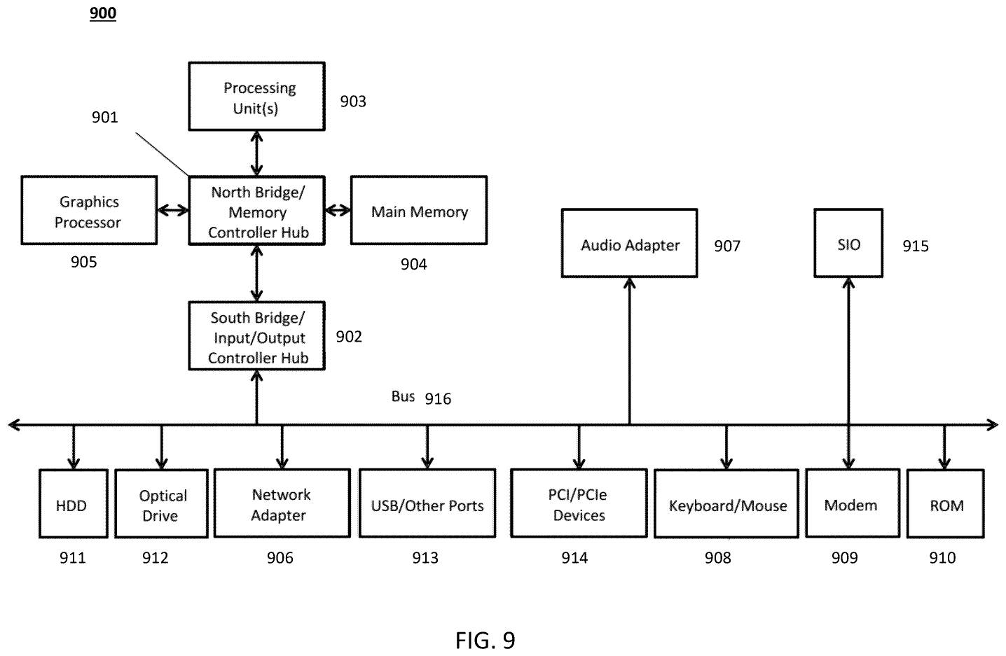

FIG. 9 illustrates a block diagram of an example data processing system 900 in which embodiments are implemented. The data processing system 900 is an example of a computer, such as a server or client, in which computer usable code or instructions implementing the process for illustrative embodiments of the present invention are located. In some embodiments, the data processing system 900 may be a server computing device. For example, the data processing system 900 may be implemented in a server or another similar computing device processing the software toolkit described above.

In the depicted example, the data processing system 900 may employ a hub architecture including a north bridge and memory controller hub (NB/MCH) 901 and south bridge and input/output (I/O) controller hub (SB/ICH) 902. A processing unit 903, a main memory 904, and a graphics processor 905 may be connected to the NB/MCH 901. The graphics processor 905 may be connected to the NB/MCH 901 through, for example, an accelerated graphics port (AGP).

In the depicted example, a network adapter 906 connects to the SB/ICH 902. An audio adapter 907, a keyboard and mouse adapter 908, a modem 909, a read only memory (ROM) 910, a hard disk drive (HDD) 911, an optical drive (e.g., CD or DVD) 912, a universal serial bus (USB) ports and other communication ports 913, and PCI/PCIe devices 914 may connect to the SB/ICH 902 through a bus system 916. The PCI/PCIe devices 914 may include Ethernet adapters, add-in cards, and/or PC cards for notebook computers. The ROM 910 may be, for example, a flash basic input/output system (BIOS). The HDD 911 and the optical drive 912 may use an integrated drive electronics (IDE) or serial advanced technology attachment (SATA) interface. A super I/O (SIO) device 915 may be connected to the SB/ICH 902.

An operating system may run on the processing unit 903. The operating system may coordinate and provide control of various components within the data processing system 900. As a client, the operating system may be a commercially available operating system. An object-oriented programming system, such as the Java™ programming system, may run in conjunction with the operating system and provide calls to the operating system from the object-oriented programs or applications executing on the data processing system 900. As a server, the data processing system 900 may be an IBM® eServer™ System® running the Advanced Interactive Executive operating system or the Linux operating system. The data processing system 900 may be a symmetric multiprocessor (SMP) system that includes a plurality of processors in the processing unit 903. Alternatively, a single processor system may be employed.

Instructions for the operating system, the object-oriented programming system, and applications or programs are located on storage devices, such as the HDD 911, and are loaded into the main memory 904 for execution by the processing unit 903. The processes for embodiments described herein may be performed by the processing unit 903 using computer usable program code, which can be located in a memory such as, for example, main memory 904, ROM 910, or in one or more peripheral devices.

A bus system 916 may comprise one or more busses. The bus system 916 may be implemented using any type of communication fabric or architecture that provides for a transfer of data between different components or devices attached to the fabric or architecture. A communication unit such as the modem 909 or the network adapter 906 may include one or more devices that can be used to transmit and receive data.

Those of ordinary skill in the art will appreciate that the hardware depicted in FIG. 9 may vary depending on the implementation. Other internal hardware or peripheral devices, such as flash memory, equivalent non-volatile memory, or optical disk drives may be used in addition to or in place of the hardware depicted. Moreover, the data processing system 900 can take the form of any of a number of different data processing systems, including but not limited to, client computing devices, server computing devices, tablet computers, laptop computers, telephone or other communication devices, personal digital assistants, and the like. Essentially, data processing system 900 can be any known or later developed data processing system without architectural limitation.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure as come within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is also to be understood that the terminology used herein is for the purpose of describing particular embodiments only and is not intended to be limiting.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed:

1. A software toolkit for research and discovery, comprising:
a data model defining entity objects and document objects using an object-relational mapping framework;
a configuration system for describing object data structures through a declarative schema definition language;
a rendering engine for generating user interface components based on the configuration system, utilizing virtual document object model implementations and state management libraries;
a linking system for connecting the entity objects and the document objects using graph algorithms comprising at least one of: shortest path algorithms, centrality measures, and community detection algorithms; and
a search and exploration interface for accessing and analyzing the linked entity objects and the linked document objects.
